(19) United States
(12) Patent Application Publication
(10) Pub. No.: US 2015/0161656 A1
(43) Pub. Date: Jun. 11, 2015

(54) SOFTWARE-CONVERSATION-AGENT INTERACTIVE ADVERTISING SYSTEMS AND METHODS

(71) Applicants: Andres C. RODRIGUEZ, Los Angeles, CA (US); Juan C. VERA, Mexico City (MX); David JIMENEZ, Mexico City (MX); Gibrán J. CRUZ, Mexico City (MX); Juan S. CASCAJARES, Mexico City (MX)

(72) Inventors: Andres C. RODRIGUEZ, Los Angeles, CA (US); Juan C. VERA, Mexico City (MX); David JIMENEZ, Mexico City (MX); Gibrán J. CRUZ, Mexico City (MX); Juan S. CASCAJARES, Mexico City (MX)

(21) Appl. No.: 14/101,232

(22) Filed: Dec. 9, 2013

(51) Int. Cl. G06Q 30/02; H04L 29/08

(52) U.S. Cl. CPC G06Q 30/0245; G06Q 30/0277; H04L 67/10

(57) ABSTRACT

An interactive advertising service may be provided using a software conversation agent configured to promote products and/or services via a trained classifier and a hierarchy of concepts related to the products and/or services. Upon request, an interactive advertisement is provided for display to a remote user via a third-party content page, the advertisement including a first creative asset and a linguistic communication control. A world state is obtained and updated during a conversational interaction with the remote user. When free-form linguistic input is received from the remote user, the input is classified and the world state updated. When the world state matches a product and/or service, the interactive advertisement is updated to display a second creative asset corresponding to the matching product and/or service.

### FIELD

This disclosure is directed to the field of software, and more particularly, to providing an interactive advertising service based on software conversation agents.

### BACKGROUND

Online advertising uses the Internet to deliver promotional marketing messages to consumers. Online advertising includes email marketing, search engine marketing, social media marketing, many types of display advertising (including web banner advertising), and mobile advertising. Like other advertising media, online advertising frequently involves both a publisher, who integrates advertisements into its online content, and an advertiser, who provides the advertisements to be displayed on the publisher's content. Other potential participants include advertising agencies who help generate and place the ad copy, an ad server who technologically delivers the ad and tracks statistics, and advertising affiliates who do independent promotional work for the advertiser.

A traditional web banner or banner ad is typically embedded into a web page. Banner ads are typically intended to attract traffic to a website by linking to the website of the advertiser. In many cases, banners are delivered by a central ad server.

Advertisers typically pay for online advertising according to one of several regimes, including regimes such as cost per impression, cost per click, and cost per order. Such regimes measure various metrics (e.g., a count of ad impressions, a count of clicks on ads, a count of purchases that result from an ad impression) associated with an online advertising campaign.

Generally, metrics that do not necessarily correspond closely to consumer engagement are less valuable to an advertiser than metrics that indicate actual consumer interest and/or engagement with the advertisement and/or the advertised products and/or services. For example, mere “impressions” are usually valued less than “clicks” or follow-through actions such as purchases, sign-ups, and the like.

Moreover, advertisers use many different methods to track consumer behavior and to make inferences about which products and/or services a given consumer may be interested in. But as such “targeting” methods have become increasingly sophisticated, they have also become increasingly invasive. In some cases, reasonable inferences about a consumer's interests may be drawn based on tracking a consumer's online activity and/or profiling a consumer. But in many cases, such targeted advertising is of limited effectiveness, especially considering that many consumers object to being stealthily tracked and profiled by advertisers.

Although many options for tracking and measuring the performance of online advertising exist, advertisers still often lack the ability to measure consumer engagement with an online advertisement and to provide marketing information about products and/or services that a given consumer is actually interested in.

### BRIEF DESCRIPTION OF THE DRAWINGS

FIG. 1 illustrates a simplified software-conversation-agent-based interactive advertising system in which content-provider device, interactive-advertisement server, client device, and human-operator device are connected to network.

FIG. 2 illustrates an exemplary series of communications between client device, content-provider device, and interactive-advertisement server in accordance with one embodiment.

FIG. 3 illustrates an interactive-advertising routine for providing a software-conversation-agent-based interactive advertising service, such as may be performed by an interactive-advertisement server in accordance with one embodiment.

FIG. 4 illustrates a conversational-interaction subroutine for conversationally interacting with a given remote user as a software conversation agent via a given linguistic communication control to promote products and/or services, such as may be performed by an interactive-advertisement server in accordance with one embodiment.

FIG. 5 illustrates a classifier subroutine for classifying a given free-form linguistic input, such as may be performed by an interactive-advertisement server in accordance with one embodiment.

FIG. 6 illustrates a world-state-update subroutine for updating a given world state according to one or more given concepts, such as may be performed by an interactive-advertisement server in accordance with one embodiment.

FIG. 7 illustrates a response-string subroutine for assembling a conversational response string based at least in part on a given world state associated with a given remote user, such as may be performed by an interactive-advertisement server in accordance with one embodiment.

FIG. 8 illustrates an exemplary content page display including an interactive advertisement such as may be presented to a user on a client device, in accordance with one embodiment.

FIG. 9 illustrates several components of an exemplary interactive-advertisement server in accordance with one embodiment.

### DESCRIPTION

In various embodiments, an interactive advertising service may enable remote consumers to conduct interactive conversations with a software conversation agent configured to promote various products and/or services. Such consumer interactions may provide value to advertisers by collecting rich data about consumer engagement and interest in products and/or services, and they may provide value to consumers by allowing them to obtain particularized information and indicate their interest in particular products and/or services.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

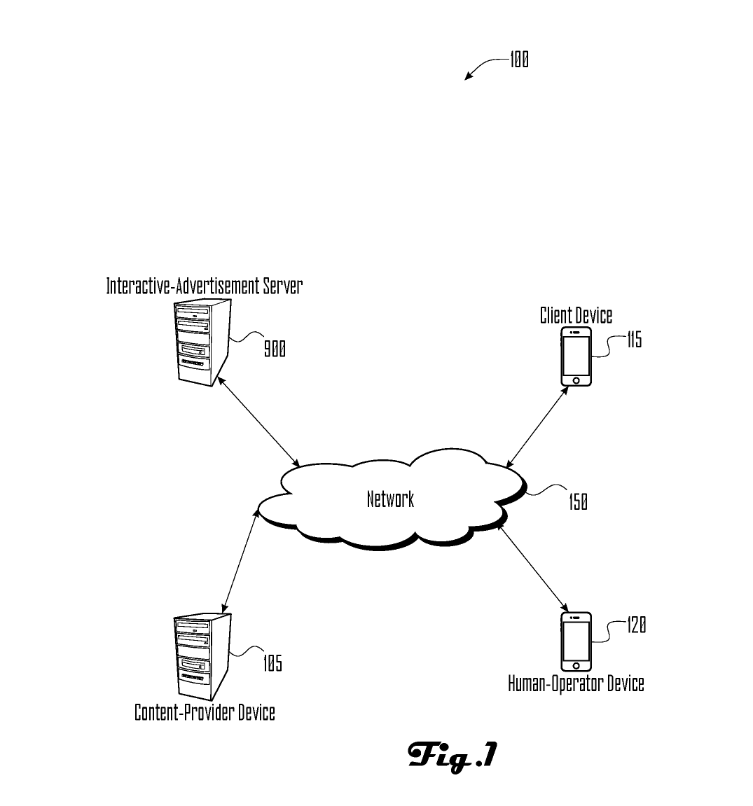

FIG. 1 illustrates a simplified software-conversation-agent-based interactive advertising system 100 in which content-provider device 105, interactive-advertisement server 900, client device 115, and human-operator device 120 are connected to network 150.

Content-provider device 105 provides content pages on which advertising is displayed.

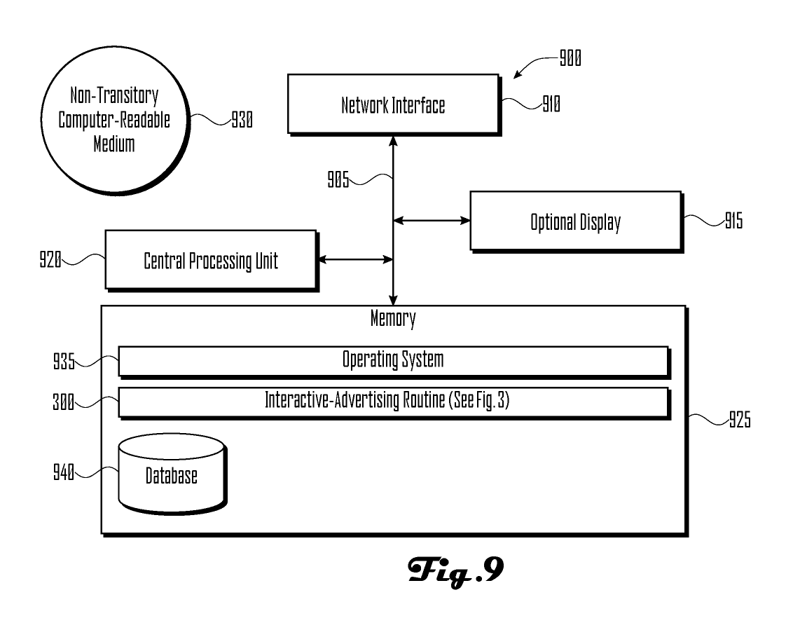

Interactive-advertisement server 900 (see FIG. 9, discussed below) provides software-conversation-agent-based interactive advertising services, as discussed below.

In various embodiments, client device 115 and human-operator device 120 may include desktop PCs, mobile phones, laptops, tablets, or other computing devices that are capable of connecting to network 150 and consuming services such as those described herein.

In various embodiments, network 150 may include the Internet, a local area network (“LAN”), a wide area network (“WAN”), and/or other data network.

In various embodiments, additional infrastructure (e.g., cell sites, routers, gateways, firewalls, and the like), as well as additional devices may be present. Further, in some embodiments, the functions described as being provided by some or all of content-provider device 105 and interactive-advertisement server 900 may be implemented via various combinations of physical and/or logical devices. However, it is not necessary to show such infrastructure and implementation details in FIG. 1 in order to describe an illustrative embodiment.

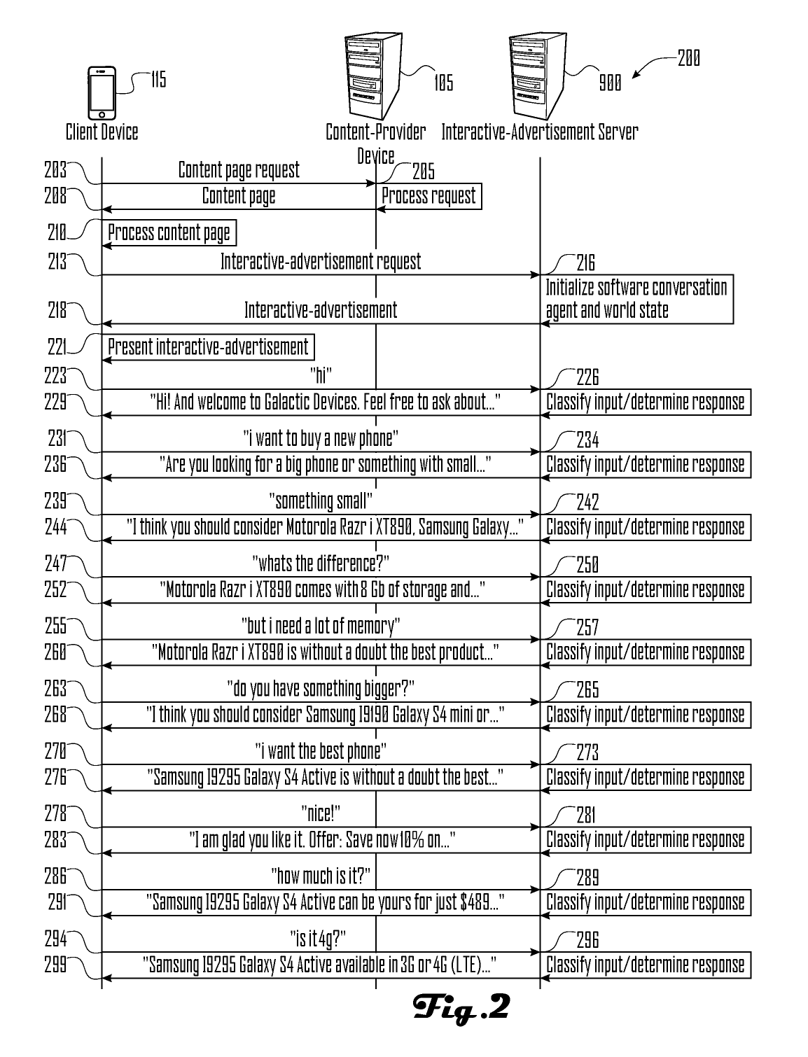

FIG. 2 illustrates an exemplary series of communications between client device 115, content-provider device 105, and interactive-advertisement server 900 in accordance with one embodiment. The communications shown in FIG. 2 do not encompass every combination of possibilities in which the systems and methods provided herein may be employed. Rather, the illustrated communications merely provide an overview of one simplified example scenario. Additional variations and alternatives are described more fully in the Figures and description that follow.

Detailed data relating to the illustrated scenario is shown in Appendix I, below. Appendices A-H include a subset of the classification and product data that may be employed by a software conversation agent and/or its trained classifier to interact with the consumer in the illustrated scenario.

Beginning the illustrated sequence of communications, client device 115 requests 203 a content page.

Content-provider device 105 processes 205 the request and sends to client device 115 the requested content page 208 (including an interactive-advertising identifier).

Client device 115 processes 210 the request and client device 115 sends to interactive-advertisement server 900.

Interactive-advertisement server 900 initializes 216 a software conversation agent configured to promote certain products and/or services and a world state data structure to store information about the user's stated intentions and desires. For example, in one embodiment, interactive-advertisement server 900 may initialize a data structure including data similar to some or all of the following.

userNeedCategories: memory~dimensions~tier~product_type
userNeeds: high memory~phone~high end~big dimensions
attributeName: connectivity

To facilitate human comprehension, this and other example data objects depicted herein (including in Appendices A-I) are presented according to version 1.2 of the YAML “human friendly data serialization standard”, specified at http://www.yaml.org/spec/1.2/spec.html. In practice, data objects may be serialized for storage and/or transmission into any suitable format (e.g., YAML, JSON, XML, BSON, Property Lists, or the like).

The software conversation agent also includes a trained classifier, such as a naive Bayes classifier, that has been trained to classify inputs related to the promotional products and/or services. In other embodiments, the trained classifier may comprise another type of linear classifier, a neural network, a support vector machine, or the like.

Interactive-advertisement server 900 sends to client device 115 (including at least one creative asset and a linguistic communication control).

Client device 115 presents 221 interactive-advertisement.

Client device 115 sends to interactive-advertisement server 900 the following free-form linguistic input 223, “hi”.

Interactive-advertisement server 900 classifies 226 the input, updates the world state accordingly, and determines an appropriate response. In the illustrated scenario, interactive-advertisement server 900 may classify the input into a classification such as ‘greeting’. After classifying and processing the current free-form linguistic input as discussed above, the world state data structure may include data such as some or all of the following.

userNeedCategories: “”
userNeeds: “”
attributeName: “null”

Interactive-advertisement server 900 sends to client device 115 the following conversational string 229.
Hi! And welcome to Galactic Devices. Feel free to ask about our mobile devices or if you are interested in any particular feature. Special offer: Save 10% on any device buying online.

Client device 115 receives and presents the conversational string 229 to the user, who responds by providing additional free-form linguistic input. Client device 115 sends to interactive-advertisement server 900 the following free-form linguistic input 231, “i want to buy a new phone”.

Interactive-advertisement server 900 classifies 234 the input, updates the world state accordingly, and determines an appropriate response. In the illustrated scenario, interactive-advertisement server 900 may classify the input into a classification such as ‘ask_suggestion’. In the illustrated scenario, interactive-advertisement server 900 may further determine that the current input indicates that the user has indicated a concept category such as ‘product_type’.

However, here, interactive-advertisement server 900 determines that it cannot confidently match the world state to one or more products and/or services that the user may be interested in. Consequently, interactive-advertisement server 900 determines that it should pose a question to the user to solicit further input that may allow interactive-advertisement server 900 to make a better product and/or service match. After classifying and processing the current free-form linguistic input as discussed above, the world state data structure may include data such as some or all of the following.

userNeedCategories: product_type
userNeeds: phone
attributeName: tier

Interactive-advertisement server 900 sends to client device 115 the following conversational string 236.
Are you looking for a big phone or something with small dimensions?

Client device 115 receives and presents the conversational string 236 to the user, who responds by providing additional free-form linguistic input. Client device 115 sends to interactive-advertisement server 900 the following free-form linguistic input 239, “something small”.

Interactive-advertisement server 900 classifies 242 the input, updates the world state accordingly, and determines an appropriate response. In the illustrated scenario, interactive-advertisement server 900 may classify the input into a classification such as ‘ask_suggestion’. As discussed above, in the illustrated scenario, the current world state indicates that the user has indicated a concept category such as ‘dimensions’. Here, interactive-advertisement server 900 determines that it can match the world state to several potential products and/or services that the user may be interested in. Consequently, interactive-advertisement server 900 assembles a conversational string listing the potentially interesting products and/or services. After classifying and processing the current free-form linguistic input as discussed above, the world state data structure may include data such as some or all of the following.

userNeedCategories: dimensions~product_type
userNeeds: phone~small dimensions
attributeName: dimensions

Interactive-advertisement server 900 sends to client device 115 the following conversational string 244.
I think you should consider Motorola Razr i XT890, Samsung Galaxy Fame or Motorola Razr D3 XT919. If you are interested please write your email and I will send you the offer details.

Client device 115 receives and presents the conversational string 244 to the user, who responds by providing additional free-form linguistic input. Client device 115 sends to interactive-advertisement server 900 the following free-form linguistic input 247, “whats the difference?”.

Interactive-advertisement server 900 classifies 250 the input, updates the world state accordingly, and determines an appropriate response. In the illustrated scenario, interactive-advertisement server 900 may classify the input into a classification such as ‘ask_difference’. As discussed above, in the illustrated scenario, the current world state indicates that the user has indicated a concept category such as ‘dimensions’. Consequently, interactive-advertisement server 900 assembles a conversational string comparing the dimensions of the proposed alternative products and/or services. After classifying and processing the current free-form linguistic input as discussed above, the world state data structure may include data such as some or all of the following.

userNeedCategories: dimensions~product_type
userNeeds: phone~small dimensions
attributeName: dimensions

Interactive-advertisement server 900 sends to client device 115 the following conversational string 252.
Motorola Razr i XT890 comes with 8 Gb of storage and microSD slot, prices starts at 649USD, is the perfect high-end device Motorola Razr D3 XT919 comes with 4 Gb of storage and microSD slot, prices starts at 449USD, is a good mid-end device Samsung Galaxy Fame has 512 Mb of RAM, can be yours for just 399USD, comes with low and midrange features

Client device 115 receives and presents the conversational string 252 to the user, who responds by providing additional free-form linguistic input. Client device 115 sends to interactive-advertisement server 900 the following free-form linguistic input 255, “but i need a lot of memory”.

Interactive-advertisement server 900 classifies 257 the input, updates the world state accordingly, and determines an appropriate response. In the illustrated scenario, interactive-advertisement server 900 may classify the input into a classification such as ‘ask_suggestion’. As discussed above, in the illustrated scenario, the current world state indicates that the user has indicated a concept category such as ‘memory’. Here, interactive-advertisement server 900 determines that it can match the world state to a particular product and/or service that the user is likely interested in. Consequently, interactive-advertisement server 900 assembles a conversational string indicating the matching product and/or service. In addition, interactive-advertisement server 900 identifies one or more media assets associated with the recommended product and/or service. For example, in the illustrated scenario, interactive-advertisement server 900 may identify media assets similar to those identified in the following media-asset identifier strings.

- “<a href=‘http://www.youtube.com/watch?v=5zBnjotsGTg’ >”
- “<img src=‘http://184.73.254.191/cpg/img/razr%20s4%20i.jpg’ />”

After classifying and processing the current free-form linguistic input as discussed above, the world state data structure may include data such as some or all of the following.

userNeedCategories: memory~dimensions~product_type
userNeeds: high memory~phone~small dimensions
attributeName: memory

Interactive-advertisement server 900 sends to client device 115 the following conversational string 260.
Motorola Razr i XT890 is without a doubt the best product for you! is compact size comes with 8 Gb of storage and microSD slot Offer: Save now 15% on the Razr i. If you are interested please write your email and I will send you the offer details.

In addition, interactive-advertisement server 900 sends to client device 115 one or more media asset identifiers associated with the recommended product and/or service, as discussed above.

Client device 115 receives and presents the conversational string 260 to the user, who responds by providing additional free-form linguistic input. Client device 115 sends to interactive-advertisement server 900 the following free-form linguistic input 263, “do you have something bigger?”.

Interactive-advertisement server 900 classifies 265 the input, updates the world state accordingly, and determines an appropriate response. In the illustrated scenario, interactive-advertisement server 900 may classify the input into a classification such as ‘ask_suggestion’. As discussed above, in the illustrated scenario, the current world state indicates that the user has indicated a concept category such as ‘memory’. Here, interactive-advertisement server 900 determines that it can match the world state to several potential products and/or services that the user may be interested in. Consequently, interactive-advertisement server 900 assembles a conversational string listing the potentially interesting products and/or services. After classifying and processing the current free-form linguistic input as discussed above, the world state data structure may include data such as some or all of the following.

userNeedCategories: memory~dimensions~product_type
userNeeds: phone~high memory~big dimensions
attributeName: dimensions

Interactive-advertisement server 900 sends to client device 115 the following conversational string 268.
I think you should consider Samsung I9190 Galaxy S4 mini or Samsung 19295 Galaxy S4 Active. If you are interested please write your email and I will send you the offer details.

Client device 115 receives and presents the conversational string 268 to the user, who responds by providing additional free-form linguistic input. Client device 115 sends to interactive-advertisement server 900 the following free-form linguistic input 270, “i want the best phone”.

Interactive-advertisement server 900 classifies 273 the input, updates the world state accordingly, and determines an appropriate response. In the illustrated scenario, interactive-advertisement server 900 may classify the input into a classification such as ‘ask_suggestion’. As discussed above, in the illustrated scenario, the current world state indicates that the user has indicated a concept category such as ‘memory’. Here, interactive-advertisement server 900 determines that it can match the world state to a particular product and/or service that the user is likely interested in. Consequently, interactive-advertisement server 900 assembles a conversational string indicating the matching product and/or service. In addition, interactive-advertisement server 900 identifies one or more media assets associated with the recommended product and/or service. For example, in the illustrated scenario, interactive-advertisement server 900 may identify media assets similar to those identified in the following media-asset identifier strings.

- “<a href=‘http://www.youtube.com/watch?v=2LHv1FPd1Ec’ >”
- “<img src=‘http://184.73.254.191/cpg/img/galaxy%20s4%20active’ />”

After classifying and processing the current free-form linguistic input as discussed above, the world state data structure may include data such as some or all of the following.

userNeedCategories: memory~dimensions~tier~product_type
userNeeds: high memory~phone~high end~big dimensions
attributeName: tier

Interactive-advertisement server 900 sends to client device 115 the following conversational string 276.
Samsung 19295 Galaxy S4 Active is without a doubt the best product for you! is a large device has 2 Gb of RAM and 16 of storage is Samsung's flagship device Offer: Save now 10% on the Galaxy S4 Active. If you are interested please write your email and I will send you the offer details.

In addition, interactive-advertisement server 900 sends to client device 115 one or more media asset identifiers associated with the recommended product and/or service, as discussed above.

Client device 115 receives and presents the conversational string 276 to the user, who responds by providing additional free-form linguistic input. Client device 115 sends to interactive-advertisement server 900 the following free-form linguistic input 278, “nice!”.

Interactive-advertisement server 900 classifies 281 the input, updates the world state accordingly, and determines an appropriate response. In the illustrated scenario, interactive-advertisement server 900 may classify the input into a classification such as ‘good_product’. After classifying and processing the current free-form linguistic input as discussed above, the world state data structure may include data such as some or all of the following.

userNeedCategories: memory~dimensions~tier~product_type
userNeeds: high memory~phone~high end~big dimensions
attributeName: screen

Interactive-advertisement server 900 sends to client device 115 the following conversational string 283.
I am glad you like it. Offer: Save now 10% on the Galaxy S4 Active. If you are interested please write your email and I will send you the offer details. We encourage you to read our privacy policy at www.galactic.com

Client device 115 receives and presents the conversational string 283 to the user, who responds by providing additional free-form linguistic input. Client device 115 sends to interactive-advertisement server 900 the following free-form linguistic input 286, “how much is it?”.

Interactive-advertisement server 900 classifies 289 the input, updates the world state accordingly, and determines an appropriate response. In the illustrated scenario, interactive-advertisement server 900 may classify the input into a classification such as ‘ask_attribute’. In the illustrated scenario, interactive-advertisement server 900 may determine that the user has queried about a product and/or service attribute classified as ‘price’. Consequently, interactive-advertisement server 900 assembles a conversational string indicating one or more price attributes of the recommended product and/or service. In addition, interactive-advertisement server 900 identifies one or more media assets associated with the recommended product and/or service. For example, in the illustrated scenario, interactive-advertisement server 900 may identify media assets similar to those identified in the following media-asset identifier strings.
“<a href=‘http://www.youtube.com/watch?v=2LHv1FPd1Ec’ >”

After classifying and processing the current free-form linguistic input as discussed above, the world state data structure may include data such as some or all of the following.

userNeedCategories: memory~dimensions~tier~product_type
userNeeds: high memory~phone~high end~big dimensions
attributeName: price

Interactive-advertisement server 900 sends to client device 115 the following conversational string 291.
Samsung 19295 Galaxy S4 Active can be yours for just 489USD with Moon Deal 5 or 709USD with Moon Deal 2. Watch Video!

In addition, interactive-advertisement server 900 sends to client device 115 one or more media asset identifiers associated with the recommended product and/or service, as discussed above.

Client device 115 receives and presents the conversational string 291 to the user, who responds by providing additional free-form linguistic input. Client device 115 sends to interactive-advertisement server 900 the following free-form linguistic input 294, “is it 4g?”.

Interactive-advertisement server 900 classifies 296 the input, updates the world state accordingly, and determines an appropriate response. In the illustrated scenario, interactive-advertisement server 900 may classify the input into a classification such as ‘ask_attribute’. In the illustrated scenario, interactive-advertisement server 900 may determine that the user has queried about a product and/or service attribute classified as ‘connectivity’. Consequently, interactive-advertisement server 900 assembles a conversational string indicating one or more connectivity attributes of the recommended product and/or service. In addition, interactive-advertisement server 900 identifies one or more media assets associated with the recommended product and/or service. For example, in the illustrated scenario, interactive-advertisement server 900 may identify media assets similar to those identified in the following media-asset identifier strings.
“<a href=‘http://www.youtube.com/watch?v=2LHv1FPd1Ec’ >”

After classifying and processing the current free-form linguistic input as discussed above, the world state data structure may include data such as some or all of the following.

userNeedCategories: memory~dimensions~tier~product_type
userNeeds: high memory~phone~high end~big dimensions
attributeName: connectivity

Interactive-advertisement server 900 sends to client device 115 the following conversational string 299.
Samsung 19295 Galaxy S4 Active available in 3G or 4G (LTE) connections. Watch Video!

In addition, interactive-advertisement server 900 sends to client device 115 one or more media asset identifiers associated with the recommended product and/or service, as discussed above.

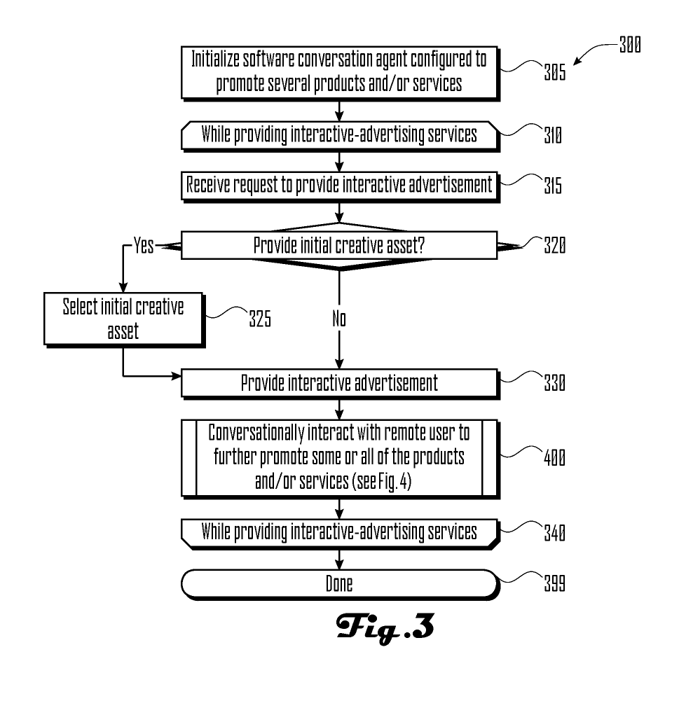

FIG. 3 illustrates an interactive-advertising routine 300 for providing a software-conversation-agent-based interactive advertising service, such as may be performed by an interactive-advertisement server 900 in accordance with one embodiment.

In block 305, interactive-advertising routine 300 initializes a software conversation agent configured to promote several products and/or services. In various embodiments, the software conversation agent includes a trained classifier and promotional data including a hierarchy of concepts related to a plurality of products and/or services. For example, in one embodiment, the software conversation agent may include a trained naive Bayes classifier and promotional data similar to some or all of that shown in Appendices A-H, including concept data similar to some or all of that shown in Appendix C and/or Appendix F. In other embodiments, instead of or in addition to a naive Bayes classifier the software conversation agent may include another type of linear classifier, a neural network, a support vector machine, or the like.

Beginning in opening loop block 310, interactive-advertising routine 300 loops to ending loop block 340 until it has finished providing interactive-advertising services. In block 315, interactive-advertising routine 300 receives a request from a remote client device (e.g., client device 115) to provide an interactive advertisement for display to a remote user via a third-party content page. For example, typically a content provider may include a link or other identifier identifying an interactive advertisement as part of the data comprising a web page or other content page. In the course of rendering the content page, the remote client device requests the interactive advertisement resource from interactive-advertising routine 300.

In decision block 320, interactive-advertising routine 300 determines whether requested interactive advertisement is configured to include an initial creative asset. If so, then interactive-advertising routine 300 proceeds to block 325; otherwise, interactive-advertising routine 300 proceeds to block 330.

In block 325, interactive-advertising routine 300 selects an initial creative asset to be provided as part of the requested advertisement.

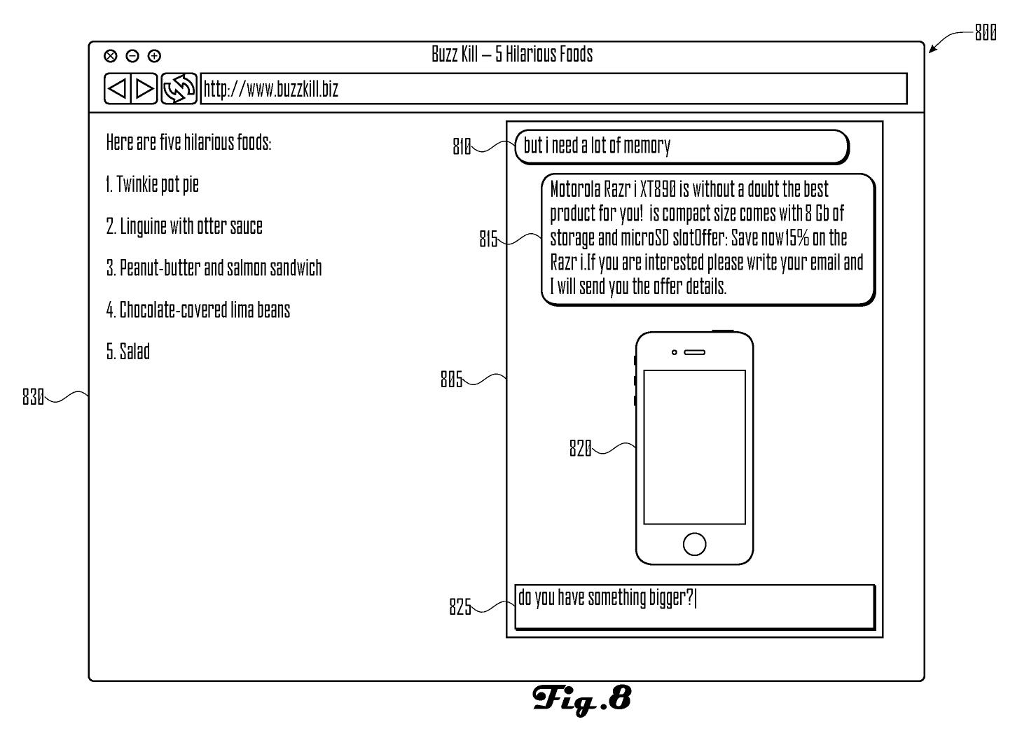

In block 330, interactive-advertising routine 300 provides the requested interactive advertisement, including the creative asset selected in block 325 (if any) and a linguistic communication control. In various embodiments, a linguistic communication control, such as input control 825 (see FIG. 8, discussed below), enables a remote user to provide free-form linguistic input, such as by typing and/or speaking natural-language phrases.

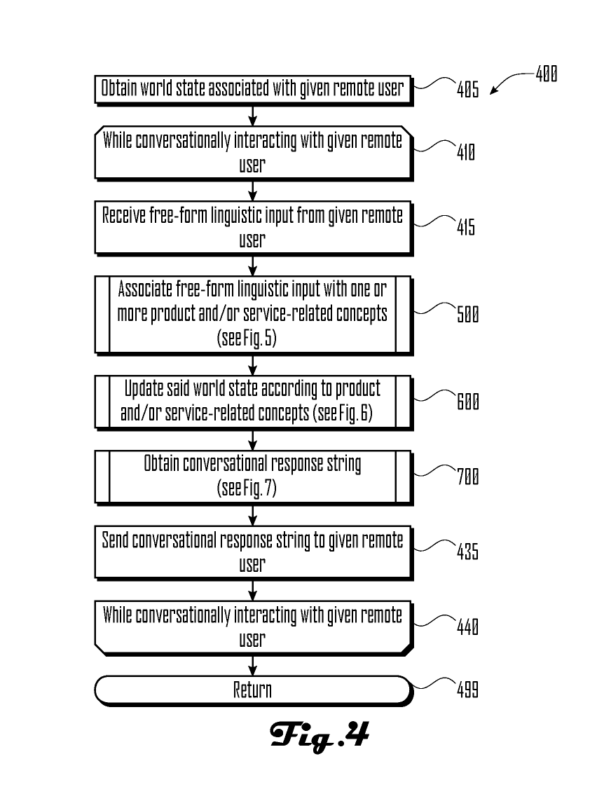

In subroutine block 400, interactive-advertising routine 300 calls subroutine 400 (see FIG. 4, discussed below) to conversationally interact with the remote user via the software conversation agent and the linguistic communication control to further promote some or all of the products and/or services.

In ending loop block 340, interactive-advertising routine 300 iterates back to opening loop block 310 if it is still providing interactive-advertising services.

Interactive-advertising routine 300 ends in ending block 399.

FIG. 4 illustrates a conversational-interaction subroutine 400 for conversationally interacting with a given remote user as a software conversation agent via a given linguistic communication control to promote products and/or services, such as may be performed by an interactive-advertisement server 900 in accordance with one embodiment.

In block 405, conversational-interaction subroutine 400 obtains a world state associated with the given remote user. In various embodiments, a world state data object may take many different forms. Appendix I illustrates several data objects corresponding to data that may be represented in a world state data object during a given turn within a conversational interaction.

In some embodiments, obtaining a world state may include initializing an empty world state or a world state that includes only information that is readily apparent, such as a current data and/or time, an IP address or similar identifier associated with the given remote user, or the like. In other embodiments, such as when the given remote user may have previously interacted with a related software conversation agent, obtaining a world state data object may include locating a pre-existing world state object associated with the given remote user.

Beginning in opening loop block 410, conversational-interaction subroutine 400 loops to ending loop block 440 until it has finished conversationally interacting with the given remote user.

In block 415, conversational-interaction subroutine 400 receives free-form linguistic input from the given remote user via the given linguistic communication control. In many embodiments, when received by conversational-interaction subroutine 400, the free-form linguistic input generally takes the form of a string or similar representation of text. In some embodiments, the free-form linguistic input may have been preprocessed by a speech-to-text engine or similar. For example, in one embodiment, conversational-interaction subroutine 400 may receive free-form linguistic input such as “i want to buy a new phone”.

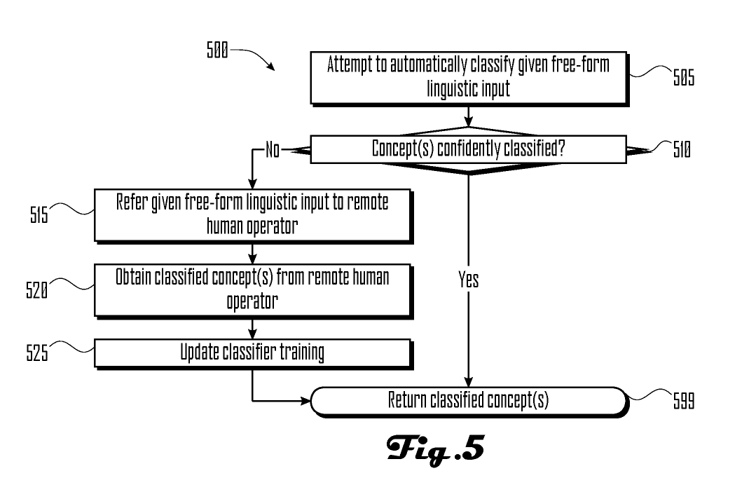

In subroutine block 500, conversational-interaction subroutine 400 calls subroutine 500 (see FIG. 5, discussed below) to associate the free-form linguistic input received in block 415 with one or more product and/or service-related concepts. For example, in one embodiment, conversational-interaction subroutine 400 may determine that the free-form linguistic input received from the given remote user is associated with a ‘product_type’ concept of ‘phone’.

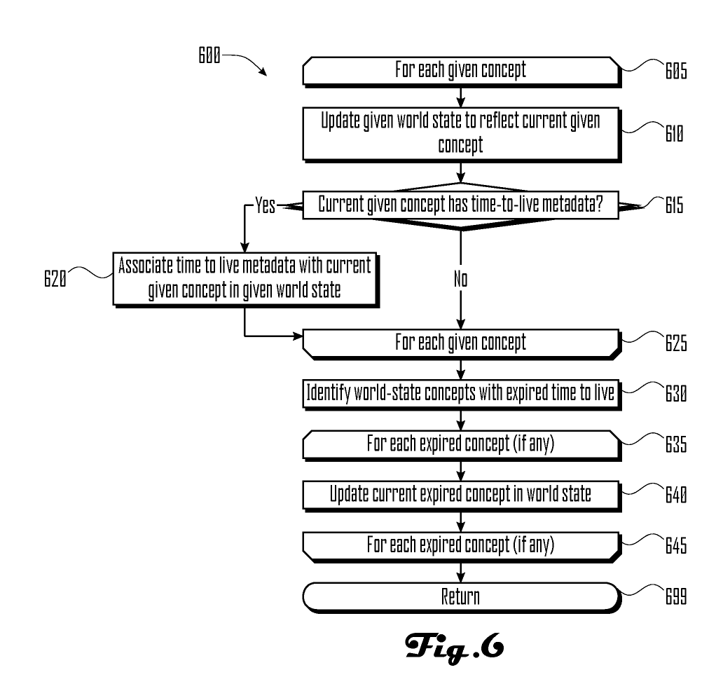

In subroutine block 600, conversational-interaction subroutine 400 calls subroutine 600 (see FIG. 6, discussed below) to update a world state obtained in block 405 according to the product and/or service-related concepts determined in classifier subroutine 500. For example, in one embodiment, the data objects illustrated in Appendix I show several world states having been updated in such a manner. See, e.g., the various concept associations shown in the values associated with keys such as ‘attributeName’, ‘socialClassification’, ‘userNeedCategories’, and ‘userNeeds’.

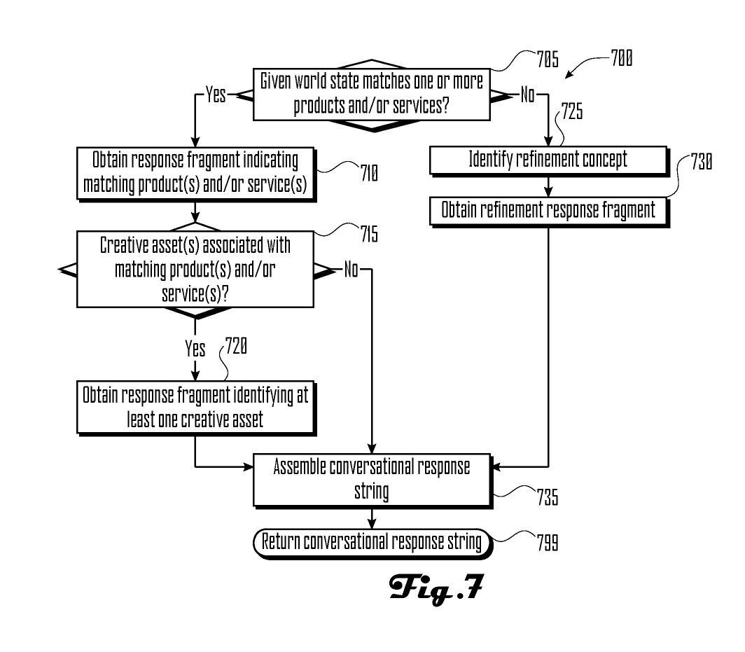

In subroutine block 700, conversational-interaction subroutine 400 calls subroutine 700 (see FIG. 7, discussed below) to obtain a conversational response string. For example, in one embodiment, conversational-interaction subroutine 400 may obtain a conversational response string such as “Are you looking for a big phone or something with small dimensions?”.

In block 435, conversational-interaction subroutine 400 sends the conversational response string to the given remote user. Cf. Conversational response string display 815 (see FIG. 8, discussed below).

In ending loop block 440, conversational-interaction subroutine 400 iterates back to opening loop block 410 if it is still conversationally interacting with given remote user.

Conversational-interaction subroutine 400 ends in ending block 499, returning to the caller.

FIG. 5 illustrates a classifier subroutine 500 for classifying a given free-form linguistic input, such as may be performed by an interactive-advertisement server 900 in accordance with one embodiment.

In block 505, classifier subroutine 500 uses the software conversation agent's trained classifier to attempt to automatically classify the given free-form linguistic input, matching the given free-form linguistic input to one or more product-and/or-service-related concepts. In some embodiments, the trained classifier may also indicate a confidence metric indicating how confident the trained classifier about the results that it obtained.

In decision block 510, classifier subroutine 500 determines whether the automatic classification performed in block 505 meets a predetermined confidence threshold, such as a 70% confidence metric. If so, then classifier subroutine 500 proceeds to ending block 599, returning the automatic classification to the caller. Otherwise, if the automatic classification's confidence metric does not meet the predetermined threshold, then classifier subroutine 500 proceeds to block 515.

In block 515, classifier subroutine 500 refers the given free-form linguistic input, as well as its conversational context, to a remote human operator, such as may be operating human-operator device 120.

In block 520, classifier subroutine 500 obtains one or more classified concept(s) from the remote human operator. In some embodiments, the remote human operator may also provide a conversational response string (or a fragment thereof) that may be subsequently used when sending a response to the remote user.

In block 525, classifier subroutine 500 uses the concept classifications and/or conversational response string (or fragment thereof) received in block 520 to update the training of the software conversation agent's trained classifier before returning the remote human operator-provider classifications to the caller in ending block 599.

Classifier subroutine 500 ends in ending block 599.

FIG. 6 illustrates a world-state-update subroutine 600 for updating a given world state according to one or more given concepts, such as may be performed by an interactive-advertisement server 900 in accordance with one embodiment.

Beginning in opening loop block 605, world-state-update subroutine 600 processes each given concept in turn.

In block 610, world-state-update subroutine 600 updates the given world state to reflect current given concept. For example, referring to the exemplary data shown in Appendix I, during turn 6, world-state-update subroutine 600 may process a concept indicating that the user made a statement that was classified as being associated with a ‘big dimensions’ concept (as regards mobile phones). Consequently, world-state-update subroutine 600 may update a portion of a world state data object such that a value associated with a key such as ‘userNeeds’ includes data similar to ‘phone˜high memory˜big dimensions’.

In decision block 615, world-state-update subroutine 600 determines whether ‘time to live’ metadata is associated with the current given concept. If so, then world-state-update subroutine 600 proceeds to block 620; otherwise, world-state-update subroutine 600 proceeds to ending loop block 625.

In block 620, world-state-update subroutine 600 associates the time to live metadata with the current given concept in the given world state. For example, in some embodiments, if the current given concept indicates that the user is currently interested in purchasing a new mobile phone, world-state-update subroutine 600 may determine to persist that information in the world state for a period of time beyond which the user is unlikely to still be interested in purchasing a new mobile phone.

In other words, if the user interacts with a software conversation agent on a Tuesday and indicates that he or she is interested in purchasing a new mobile phone, it is likely that the same user is still interested in purchasing a new mobile phone if he or she interacts with a software conversation agent on the following Wednesday. However, after several weeks or months, it is unlikely that the user would still be in the market for a new mobile phone. Consequently, in one embodiment, world-state-update subroutine 600 may determine that a concept indicating a product-interest should have a time to live on the order of several days or a few weeks.

Similarly, if a user indicated an interest in purchasing tickets to a movie on Saturday afternoon, that concept is less likely to be relevant even a few hours later, so world-state-update subroutine 600 may determine a time to live on the order of a few hours for such a concept. By contrast, if a user indicates a demographic concept, such as his or her age group, gender, or the like, that concept may have a very long or infinite time to live.

In ending loop block 625, world-state-update subroutine 600 iterates back to opening loop block 605 to process the next given concept, if any.

In block 630, world-state-update subroutine 600 identifies zero or more world-state concepts that are associated with time to live metadata that indicates that the concepts have expired.

Beginning in opening loop block 635, world-state-update subroutine 600 processes each expired concept (if any) in turn.

In block 640, world-state-update subroutine 600 updates the current expired concept in the world state. For example, in some embodiments, world-state-update subroutine 600 may delete the current expired concept from the world state. In other embodiments, world-state-update subroutine 600 may flag the current expired concept as being expired.

In ending loop block 645, world-state-update subroutine 600 iterates back to opening loop block 635 to process the next expired concept (if any), if any.

World-state-update subroutine 600 ends in ending block 699, returning to the caller.

FIG. 7 illustrates a response-string subroutine 700 for assembling a conversational response string based at least in part on a given world state associated with a given remote user, such as may be performed by an interactive-advertisement server 900 in accordance with one embodiment.

In decision block 705, response-string subroutine 700 determines whether the given world state matches one or more products and/or services that the given remote user is likely to be interested in. If so, then response-string subroutine 700 proceeds to block 710; otherwise, response-string subroutine 700 proceeds to block 725.

In block 710, response-string subroutine 700 obtains a response fragment indicating the matching product(s) and/or service(s). For example, referring to the exemplary data shown in Appendices A-H, if the given world state indicates that the given remote user is interested in a ‘battery’ attribute of a particular mobile phone, then response-string subroutine 700 may refer to data such as that shown in Appendix F to obtain a response fragment such as “comes with a Li-Ion 1900 mAh battery.”

Furthermore, in some cases, if there is a promotional offer associated with a particular product or products, response-string subroutine 700 may refer to data such as that shown in Appendix D to obtain a response fragment describing the promotional offer.

In decision block 715, response-string subroutine 700 determines whether one or more creative assets are associated with the matching products and/or services. For example, referring to the exemplary data shown in Appendices A-H, response-string subroutine 700 may refer to data such as that shown in Appendix A (particularly, to values associated with ‘productURL’ and/or ‘productImg’ keys) to determine whether one or more creative assets are associated with the matching products and/or services.

If in decision block 715, response-string subroutine 700 determines that there are one or more creative assets associated with the matching products and/or services, then response-string subroutine 700 proceeds to block 720; otherwise, response-string subroutine 700 proceeds to block 735.

In block 720, response-string subroutine 700 obtains a response fragment identifying at least one creative asset associated with the matching products and/or services. For example, using data such as that shown in Appendix A, in one embodiment, response-string subroutine 700 may obtain a response fragment similar to the following.

<a href=‘http://www.youtube.com/watch?v=2LHv1FPd1Ec’
target=‘_blank’><img

src=‘http://184.73.254.191/cpg/img/galaxy%20s4%20active’ /></a>

In block 725, response-string subroutine 700 identifies a refinement concept. For example, in one embodiment, the given world state may indicates that the given remote user is interested in distinguishing among various mobile phones based on a ‘memory’ refinement concept.

In block 730, response-string subroutine 700 obtains a refinement response fragment. For example, referring to the exemplary data shown in Appendices A-H, if the given world state indicates that the given remote user is interested in distinguishing among various mobile phones based on a ‘memory’ refinement concept, then response-string subroutine 700 may refer to data such as that shown in Appendix H to obtain a response fragment such as “Would you rather have a lot of memory or just average memory?”.

In block 735, response-string subroutine 700 assembles a conversational response string based on the various response fragments obtained above.

In ending block 799, response-string subroutine 700 returns to the caller the conversational response string assembled in block 735.

FIG. 8 illustrates an exemplary content page display 800 including an interactive advertisement such as may be presented to a user on a client device, in accordance with one embodiment.

In the illustrated exemplary content page display 800, interactive advertisement 805 is displayed on content page 830. Typically, the contents of content page 830 are provided by a content provider (e.g., content-provider device 105), while interactive advertisement 805 is provided by an advertisement server (e.g., interactive-advertisement server 900).

Previous message display 810 displays a free-form linguistic input that the user previously entered into input control 825.

Conversational response string display 815 shows a conversational response string that a software conversation agent provided in response to the free-form linguistic input shown in previous message display 810.

Along with the conversational response string shown in conversational response string display 815, the software conversation agent also provided a creative asset for display to the user as creative asset display 820.

Input control 825 enables the user to type free-form linguistic input to be sent to the remote software conversation agent. In other embodiments, input control 825 may enable a user to speak free-form linguistic input to be converted to text and sent to the remote software conversation agent.

FIG. 9 illustrates several components of an exemplary interactive-advertisement server in accordance with one embodiment. In some embodiments, interactive-advertisement server 900 may include many more components than those shown in FIG. 9. However, it is not necessary that all of these generally conventional components be shown in order to disclose an illustrative embodiment.

In various embodiments, interactive-advertisement server 900 may comprise one or more physical and/or logical devices that collectively provide the functionalities described herein. In some embodiments, interactive-advertisement server 900 may comprise one or more replicated and/or distributed physical or logical devices.

In some embodiments, interactive-advertisement server 900 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Interactive-advertisement server 900 includes a bus 905 interconnecting several components including a network interface 910, an optional display 915, a central processing unit 920, and a memory 925.

Memory 925 generally comprises a random access memory (“RAM”) and permanent non-transitory mass storage device, such as a hard disk drive or solid-state drive. The memory 925 stores program code for an interactive-advertising routine 300 for providing a software-conversation-agent-based interactive advertising service (see FIG. 3, discussed above). In addition, the memory 925 also stores an operating system 935.

These and other software components may be loaded into memory 925 of interactive-advertisement server 900 using a drive mechanism (not shown) associated with a non-transitory computer-readable medium 930, such as a floppy disc, tape, DVD/CD-ROM drive, memory card, or the like.

Memory 925 also includes database 940. In some embodiments, interactive-advertisement server 900 may communicate with database 940 via network interface 910, a storage area network (“SAN”), a high-speed serial bus, and/or via the other suitable communication technology.

In some embodiments, database 940 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

Following this description are Appendices A-I, which provide further information related to the subject matter disclosed herein. For the sake of brevity, many of the Appendices included below show only a representative portion of the data that would be present in an actual implementation.

More specifically, Appendix A illustrates an array of data objects including product and creative asset information about several mobile phones that a software conversation agent may be configured to promote.

Appendix B illustrates an array of data objects indicating various ways that a user might refer to several mobile phones that a software conversation agent may be configured to promote.

Appendix C illustrates an array of data objects indicating which of several mobile phones that a software conversation agent may be configured to promote correspond to various concepts or attributes that a user might desire.

Appendix D illustrates an array of data objects indicating data related to promotional offers associated with various mobile phones.

Appendix E illustrates an array of data objects that identify various attributes of several mobile phones that a software conversation agent may be configured to promote.

Appendix F illustrates an array of data objects that associate various response fragment strings with attributes of several mobile phones that a software conversation agent may be configured to promote.

Appendix G illustrates an array of data objects categorizing various concepts related to several mobile phones that a software conversation agent may be configured to promote.

Appendix H illustrates an array of data objects indicating various response fragments that a software conversation agent may use to solicit further input to distinguish among several mobile phone options.

Appendix I illustrates data associated with various world states that arise in the course of the exemplary scenario shown in FIG. 2.

1. A server-device-implemented method for providing a software-conversation-agent-based interactive advertising service, the method comprising:
initializing, by said server device, a software conversation agent configured to promote a plurality of products and/or services, said software conversation agent comprising a trained classifier and a hierarchy of concepts related to said plurality of products and/or services;
receiving, by said server device, a request to provide an interactive advertisement for display to a remote user via a third-party content page;
providing, by said server device, an advertisement comprising a first creative asset and a linguistic communication control, said first creative asset corresponding to a first one of said plurality of products and/or services;
obtaining, by said server device, a world state associated with said remote user;
conversationally interacting, by said server device, with said remote user via said software conversation agent and said linguistic communication control to further promote some or all of said plurality of products and/or services;
wherein conversationally interacting with said remote user comprises:
receiving free-form linguistic input from said remote user;
associating, via said trained classifier, said free-form linguistic input with one or more concepts of said hierarchy of concepts;
updating said world state according to said associated one or more concepts into an updated world state;
determining whether said updated world state matches a second one of said plurality of products and/or services; and
when said updated world state corresponds to said second one of said plurality of products and/or services, updating said advertisement to display a second creative asset via said third-party content page, said second creative asset corresponding to said second one of said plurality of products and/or services.

2. The method of claim 1, wherein conversationally interacting with said remote user further comprises:
selecting an unassociated concept of said hierarchy of concepts that is not reflected in said world state;
obtaining a question string corresponding to said unassociated concept; and
posing, via said linguistic communication control, said question string to said remote user to solicit free-form linguistic input associated with said unassociated concept.

3. The method of claim 1, wherein conversationally interacting with said remote user further comprises, when said updated world state does not correspond to any of said plurality of products and/or services, referring the conversational interaction to a remote human operator to solicit additional free-form linguistic input from said remote user via said linguistic communication control.

4. The method of claim 3, wherein conversationally interacting with said remote user further comprises:
receiving said additional free-form linguistic input; and
further updating said world state according to one or more concepts of said hierarchy of concepts that are associated with said additional free-form linguistic input to form a further-updated world state.

5. The method of claim 4, wherein conversationally interacting with said remote user further comprises:
determining that said further-updated world state matches a third one of said plurality of products and/or services; and
updating said advertisement to display a third creative asset via said third-party content page, said third creative asset corresponding to said third one of said plurality of products and/or services.

6. The method of claim 3, wherein referring the conversational interaction to said remote human operator comprises:
obtaining a response string and/or concept classification from said remote human operator based on said free-form linguistic input; and
updating said trained classifier based at least in part on said human-provided response string and/or concept classification and said free-form linguistic input.

7. The method of claim 1, wherein updating said world state comprises:
determining one or more time-to-live periods respectively associated with said associated one or more concepts; and
associating said one or more time-to-live periods with said associated one or more concepts in said world state.

8. The method of claim 7, wherein determining whether said updated world state matches said second one of said plurality of products and/or services comprises expiring one or more concept associations of said world state whose time-to-live periods have expired.

9. A computing apparatus for providing a software-conversation-agent-based interactive advertising service, the apparatus comprising a processor and a memory storing instructions that, when executed by the processor, configure the apparatus to:
initialize a software conversation agent configured to promote a plurality of products and/or services, said software conversation agent comprising a trained classifier and a hierarchy of concepts related to said plurality of products and/or services;
receive a request to provide an interactive advertisement for display to a remote user via a third-party content page;
provide an advertisement comprising a first creative asset and a linguistic communication control, said first creative asset corresponding to a first one of said plurality of products and/or services;
obtain a world state associated with said remote user;
conversationally interact with said remote user via said software conversation agent and said linguistic communication control to further promote some or all of said plurality of products and/or services;
wherein the instructions that configure the apparatus to conversationally interact with said remote user further comprise instructions configuring the apparatus to:
receive free-form linguistic input from said remote user;
associate, via said trained classifier, said free-form linguistic input with one or more concepts of said hierarchy of concepts;
update said world state according to said associated one or more concepts into an updated world state;
determine whether said updated world state matches a second one of said plurality of products and/or services; and
when said updated world state corresponds to said second one of said plurality of products and/or services, update said advertisement to display a second creative asset via said third-party content page, said second creative asset corresponding to said second one of said plurality of products and/or services.

10. The apparatus of claim 9, wherein the instructions that configure the apparatus to conversationally interact with said remote user further comprise instructions configuring the apparatus to:
select an unassociated concept of said hierarchy of concepts that is not reflected in said world state;
obtain a question string corresponding to said unassociated concept; and
pose, via said linguistic communication control, said question string to said remote user to solicit free-form linguistic input associated with said unassociated concept.

11. The apparatus of claim 9, wherein the instructions that configure the apparatus to conversationally interact with said remote user further comprise instructions configuring the apparatus to, when said updated world state does not correspond to any of said plurality of products and/or services, refer the conversational interaction to a remote human operator to solicit additional free-form linguistic input from said remote user via said linguistic communication control.

12. The apparatus of claim 11, wherein the instructions that configure the apparatus to conversationally interact with said remote user further comprise instructions configuring the apparatus to:
receive said additional free-form linguistic input; and
further update said world state according to one or more concepts of said hierarchy of concepts that are associated with said additional free-form linguistic input to form a further-updated world state.

13. The apparatus of claim 12, wherein the instructions that configure the apparatus to conversationally interact with said remote user further comprise instructions configuring the apparatus to:
determine that said further-updated world state matches a third one of said plurality of products and/or services; and
update said advertisement to display a third creative asset via said third-party content page, said third creative asset corresponding to said third one of said plurality of products and/or services.

14. The apparatus of claim 11, wherein the instructions that configure the apparatus to refer the conversational interaction to said remote human operator further comprise instructions configuring the apparatus to:
obtain a response string and/or concept classification from said remote human operator based on said free-form linguistic input; and
update said trained classifier based at least in part on said human-provided response string and/or concept classification and said free-form linguistic input.

15. A non-transitory computer-readable storage medium having stored thereon instructions that, when executed by a processor, configure the processor to:
initialize a software conversation agent configured to promote a plurality of products and/or services, said software conversation agent comprising a trained classifier and a hierarchy of concepts related to said plurality of products and/or services;
receive a request to provide an interactive advertisement for display to a remote user via a third-party content page;
provide an advertisement comprising a first creative asset and a linguistic communication control, said first creative asset corresponding to a first one of said plurality of products and/or services;
obtain a world state associated with said remote user;
conversationally interact with said remote user via said software conversation agent and said linguistic communication control to further promote some or all of said plurality of products and/or services;
wherein the instructions that configure the processor to conversationally interact with said remote user further comprise instructions configuring the processor to:
receive free-form linguistic input from said remote user;
associate, via said trained classifier, said free-form linguistic input with one or more concepts of said hierarchy of concepts;
update said world state according to said associated one or more concepts into an updated world state;
determine whether said updated world state matches a second one of said plurality of products and/or services; and
when said updated world state corresponds to said second one of said plurality of products and/or services, update said advertisement to display a second creative asset via said third-party content page, said second creative asset corresponding to said second one of said plurality of products and/or services.

16. The non-transitory computer-readable storage medium of claim 15, wherein the instructions that configure the processor to conversationally interact with said remote user further comprise instructions configuring the processor to:
select an unassociated concept of said hierarchy of concepts that is not reflected in said world state;
obtain a question string corresponding to said unassociated concept; and
pose, via said linguistic communication control, said question string to said remote user to solicit free-form linguistic input associated with said unassociated concept.

17. The non-transitory computer-readable storage medium of claim 15, wherein the instructions that configure the processor to conversationally interact with said remote user further comprise instructions configuring the processor to, when said updated world state does not correspond to any of said plurality of products and/or services, refer the conversational interaction to a remote human operator to solicit additional free-form linguistic input from said remote user via said linguistic communication control.

18. The non-transitory computer-readable storage medium of claim 17, wherein the instructions that configure the processor to conversationally interact with said remote user further comprise instructions configuring the processor to:
receive said additional free-form linguistic input; and
further update said world state according to one or more concepts of said hierarchy of concepts that are associated with said additional free-form linguistic input to form a further-updated world state.

19. The non-transitory computer-readable storage medium of claim 18, wherein the instructions that configure the processor to conversationally interact with said remote user further comprise instructions configuring the processor to:
determine that said further-updated world state matches a third one of said plurality of products and/or services; and
update said advertisement to display a third creative asset via said third-party content page, said third creative asset corresponding to said third one of said plurality of products and/or services.

20. The non-transitory computer-readable storage medium of claim 17, wherein the instructions that configure the processor to refer the conversational interaction to said remote human operator further comprise instructions configuring the processor to:
obtain a response string and/or concept classification from said remote human operator based on said free-form linguistic input; and
update said trained classifier based at least in part on said human-provided response string and/or concept classification and said free-form linguistic input.
